(19) United States
(12) Patent Application Publication
(10) Pub. No.: US 2002/0047973 A1
(43) Pub. Date: Apr. 25, 2002

(54) Active matrix type liquid crystal display device

(76) Inventor: Kimikazu Matsumoto, Tokyo (JP)

Correspondence Address: McGinn & Gibb, PLLC, 8321 Old Courthouse Road, Suite 200, Vienna, VA, 22182-3817, US

(21) Appl. No.: 09/929,488

(22) Filed: Aug. 15, 2001

(30) Foreign Application Priority Data
Aug. 22, 2000 (JP) 250901/2000

(51) Int. Cl. G02F 1/1343

(52) U.S. Cl. 349/141

(57) ABSTRACT

In a lateral electric field type liquid crystal display device, it has become possible to easily rotate a liquid crystal on an opposite substrate opposing to a TFT substrate when a lateral electric field is applied on the TFT substrate, by performing a twist alignment of liquid crystal so that an initial alignment angle of the liquid crystal on the opposite substrate should be shifted from the initial alignment angle of the liquid crystal on the TFT substrate, in advance. Furthermore, when this twist angle is set to two degrees or less, a high-speed response, a low threshold value, and a high luminance can be achieved at the same time while preventing the contrast degradation.

### BACKGROUND OF THE INVENTION

1. Field of the Invention

The present invention relates to an active matrix type liquid crystal display device, and more particularly, to the structure of the display device in which the liquid crystal is capable of responding quickly to the applied voltage thereto.

2. Description of the Prior Art

The display panel of an In-Plane-Switching (IPS) type liquid crystal display device has the following characteristics: the liquid crystals are held between a pair of transparent substrates at specified intervals; and by applying the electric field effectively in parallel with the substrate, the liquid crystal molecule rotates in the plane horizontal to the substrate plane; thus a wide angle of visibility can be attained. In this case, the electric field effectively in parallel with the substrate can be realized by arranging pixel electrodes and common electrodes keeping specified interval to each other in the shape of the comb tooth on one of the transparent substrates that hold the liquid crystal therebetween. Accordingly, in the IPS-LCD, as the liquid crystal molecule is viewed only in the direction of its short axis the very wide viewing angle is achieved.

However, the IPS type LCD has such problems that the response of the liquid crystal is slow because of the structure thereof, and the threshold voltage necessary between the electrodes for changing the direction of the liquid crystal is high, and furthermore, the luminance of the display panel is low.

In the IPS type liquid crystal display device, a technique for reducing the threshold voltage is disclosed, for example, in Japanese Patent Laid-Open No. 7-306417 (hereafter, referred to as conventional example 1). In the conventional example 1, a method in which the transmitting axis of a polarizer is shifted by one degree or more to the initial aligning direction of the liquid crystal in the rotating direction of the molecule axis of the liquid crystal under the voltage applied.

Furthermore, a technique for increasing the response speed is disclosed, for example, in Japanese Patent Laid-Open No. 10-73823 (hereafter, referred to as conventional example 2). In the conventional example 2, a method in which the angle β1 made between the direction of the lateral electric field and the initial aligning direction of the liquid crystal molecule on one alignment film side, and the angle β2 made between the direction of the lateral electric field and the initial aligning direction of the liquid crystal molecule on the other alignment film side are set to β1=β2, and furthermore, the angle made between the direction of the lateral electric field and the transmitting axis of the one polarizer is approximately set to zero degree.

By investigating the cause of the above described problems, it is concluded that the slow response in the IPS-LCD is caused by the following facts: That is, in the case where the comb tooth shaped electrodes are formed so that the lateral electric field in parallel with the substrate is generated only on the TFT substrate, and besides, the CF material is formed on the opposite substrate opposing to the TFT substrate, the intensity difference of the electric field between the places near the TFT substrate and the opposite substrate occurs. Accordingly, it has become clear that even when a strong electric field is generated near the TFT substrate, a weak electric field is generated near the opposite substrate, and therefore, it takes substantially a long time to rotate the liquid crystal. It has been understood that when the cell gap is 4.5 μm, when comparing the electric field intensity near the TFT substrate and the electric field intensity near the opposite substrate, the latter one is about half of the previous one.

The above-described liquid crystal aligning figure will be shown schematically referring to the drawings. FIG. 1A is a plan view in which the TFT substrate is viewed from the liquid crystal side, and FIG. 1B is a cross sectional view seen when cutting the TFT substrate, liquid crystal, and CF substrate by a plane, which passes through a line A-A′, orthogonal to the TFT substrate of FIG. 1A.

The display cell shown in the drawing mainly comprises: a TFT substrate 300 including a first glass substrate 51; a CF (abbreviation of Color Filter, and hereafter, referred to simply as CF) substrate 400 including a second glass substrate 71, and a liquid crystal 70 held between the TFT substrate 300 and the CF substrate 400.

On one surface of the first glass substrate 51, a gate electrode 52, a common electrode 53, a first insulating film 54, an a-Si (abbreviation of Amorphous-Silicon, and hereafter, referred to simply as a-Si) film 65, a source electrode 56, a drain electrode 57, a pixel electrode 58, a data line 55, and a protective film 60 are formed. On the other surface of the first glass substrate 51, a polarizer 380 is formed.

On the other hand, on one surface of the second glass substrate 71, a black matrix 72, a color filter 73, and a second insulating film 74 are formed. On the other surface of the second glass substrate 71, a conductive film 490 and a polarizer 480 are formed in order.

Furthermore, on the uppermost surface on the opposing side of each substrate, an alignment layer is formed by a method of offset printing or the like.

The alignment layers of the TFT substrate 300 and the CF substrate 400 are processed so that the alignment layers are aligned in the same direction by rubbing, and thus an alignment layer 61 is formed on each surface (the rubbing direction of the alignment layer on the TFT substrate side is indicated by G, and the rubbing direction of the alignment layer on the CF substrate side is indicated by H).

These two substrates are combined holding a cell gap material (omitted in the drawing) between them with a specified distance, and by enclosing the liquid crystal 70 in that space, such a liquid crystal panel as shown in the cross sectional view of FIG. 1B is formed.

FIG. 2 typically shows the state of change indicated by the angle (angle of deviation φ(Z)) made between the long axis direction of the liquid crystal and the length direction of the comb tooth shaped electrode of the pixel electrode (the common electrode may be selected, instead) in the plane in parallel with the substrate along the straight line from the TFT substrate surface to the CF substrate surface (distance in the cell thickness direction). A broken line indicated in FIG. 2A shows the alignment state (initial alignment, φ(0)) of the liquid crystal in the cell thickness direction in the state of no applied voltage in the conventional display cell. Accordingly, FIG. 2A shows the situation where in the conventional display cell, and in the state of no voltage applied between the pixel electrode and the common electrode, the liquid crystal near the alignment layer 61 of the CF substrate 400 shows the same deviation as the liquid crystal near the alignment layer 61 of the TFT substrate 300, that is, the long axis directions of the liquid crystals are coincident.

In the IPS-LCD operated in a normally black mode, the pixel electrode voltage V(Pi) is equal to the common electrode voltage V(Com), and therefore, the liquid crystal 70 becomes in the state of no applied voltage, and is arranged uniformly showing the initial alignment angle φ(0) with respect to the longitudinal direction of the common electrode 53 or the pixel electrode 58 in FIG. 1A, along a distance Z in the cell thickness direction from the surface of the orientation film 61 of the TFT substrate 300.

On the other hand, in the case where the voltage is applied between the common electrode 53 and the pixel electrode 58 in FIG. 1A to generate the electric field for rotating the liquid crystal in a lateral direction, that is, when a potential difference is generated between V(Pi) and V(Com), the liquid crystal 70 rotates in proportion to the electric field intensity between the electrodes, and then becomes in a stable alignment state.

A broken line shown in FIG. 2B schematically shows the alignment state of the liquid crystal 70 in the cell thickness direction in the case where an electric field is generated in the conventional display cell. On the TFT substrate 300 side where the comb tooth shaped common electrode 53 and pixel electrode 58 are formed, the electric field intensity between the electrodes is strong, and therefore, the liquid crystal 370 shown in FIG. 1B largely rotates from the initial alignment angle φ(0). On the contrary, only a comparatively weak electric field is applied to the liquid crystal 470 near the CF substrate 400 shown in FIG. 1B, and therefore, the liquid crystal 470 rotates less than the liquid crystal 370 does.

FIG. 3 is a driving characteristic graph of a conventional IPS type liquid crystal display device. As shown in the graph, in the IPS type liquid crystal display device, in the case where the distance L between the common electrode 53 and the pixel electrode 58 shown in FIG. 1B is 7 μm, and besides, the cell gap d is 2 μm or more, the electric field intensity near the TFT substrate 300 is considerably different from that near the CF substrate 400, and therefore, when an electric field is generated between the pixel electrode 58 and the common electrode 53, the liquid crystal near the CF substrate 400 does not rotate so much as that near the TFT substrate 300.

In the IPS-LCD, this ununiformity of the electric field in the cell thickness direction has been the cause of such problems that the response of the liquid crystal is slow, and the threshold voltage necessary between the electrodes for changing the direction of the liquid crystal is high, and furthermore, the luminance of the display panel is low.

In both of the conventional example 1 and the conventional example 2 the electric field becomes weaker in proportion to the distance from the surface of the TFT substrate in the cell thickness direction, but the method that makes it possible to easily rotate the liquid crystal near the CF substrate in which the electric field is weakened is not shown. Accordingly, the conventional IPS mode LCD has still had the above-described problems, because of the ununiformity of the electric field in the cell thickness direction.

### SUMMARY OF THE INVENTION

Accordingly, it is an object of the present invention to provide an active matrix type liquid crystal display device with a structure that makes it easy to rotate the liquid crystal near the opposite substrate disposed opposing to the substrate where the electric field in the lateral direction is generated.

The active matrix type liquid crystal display device of the present invention that attains the above described object has a configuration including: a TFT substrate comprising a common wiring and a source/drain wiring provided on a first substrate, and an alignment layer covering the common wiring and the source and drain wiring on the first substrate; an opposite substrate disposed opposing to the TFT substrate and comprising a second substrate and an alignment layer covering the second substrate; and a liquid crystal held between the TFT substrate and the opposite substrate. In this configuration, there is such a characteristic that the common wiring and the source/drain wiring include a common electrode and a pixel electrode wired in parallel with each other, respectively, and that the angle made between the direction in which the alignment layer on the first substrate side is subjected to the aligning treatment and the direction in which the alignment layer on the second substrate side is subjected to the aligning treatment is 0.5 to 4.0 degrees.

As a modified configuration of the above-described active matrix type liquid crystal display device of the present invention, the opposite substrate includes a color filter formed on the second substrate and below the alignment layer.

As another modified configuration of the above-described active matrix type liquid crystal display device of the present invention, the TFT substrate includes a color filter formed on the first substrate and below the alignment layer.

Furthermore, in a preferred embodiment of the above described active matrix type liquid crystal display device of the present invention including the above two modified configurations, the angle made between the direction in which the alignment layer on the first substrate side is subjected to the aligning treatment and the direction in which the alignment layer on the second substrate side is subjected to the aligning treatment is 1.5 to 2.0 degrees.

Furthermore, in another preferred embodiment of the above described active matrix type liquid crystal display device of the present invention including the above two modified configurations, the direction in which the alignment layer on the first substrate side is subjected to the aligning treatment makes an angle of 5 to 45 degrees with respect to the direction in which the common electrode and the pixel electrode are wired in parallel with each other.

Moreover, in another preferred embodiment of the above described active matrix type liquid crystal display device of the present invention including the above two modified configurations, the angle made between the direction in which the alignment layer on the second substrate side is subjected to the aligning treatment and the direction in which the common electrode and the pixel electrode are wired in parallel with each other is larger than the angle made between the direction in which the alignment layer on the first substrate side is subjected to the aligning treatment and the direction in which the common electrode and the pixel electrode are wired in parallel with each other.

### BRIEF DESCRIPTION OF THE DRAWINGS

This above-mentioned and other objects, features and advantages of this invention will become more apparent by reference to the following detailed description of the invention taken in conjunction with the accompanying drawings, wherein:

FIG. 1A is a plan view of a TFT substrate of a conventional active matrix type liquid crystal display device, and FIG. 1B is a cross sectional view of a liquid crystal panel along a cutting line of FIG. 1A;

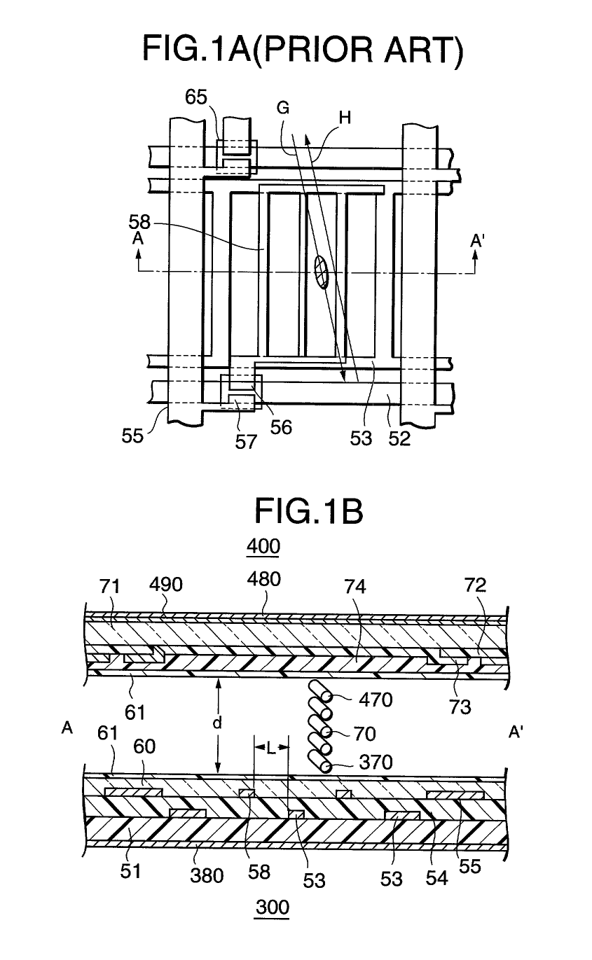

FIG. 2A and FIG. 2B are graphs showing a state of the liquid crystal rotating, together with a state of the liquid crystal in the conventional liquid crystal display device, for showing an effect of the present invention;

FIG. 3 is a graph showing a cell gap dependence of the intensity of the electric field near the TFT substrate and near a CF substrate of the active matrix type liquid crystal display device;

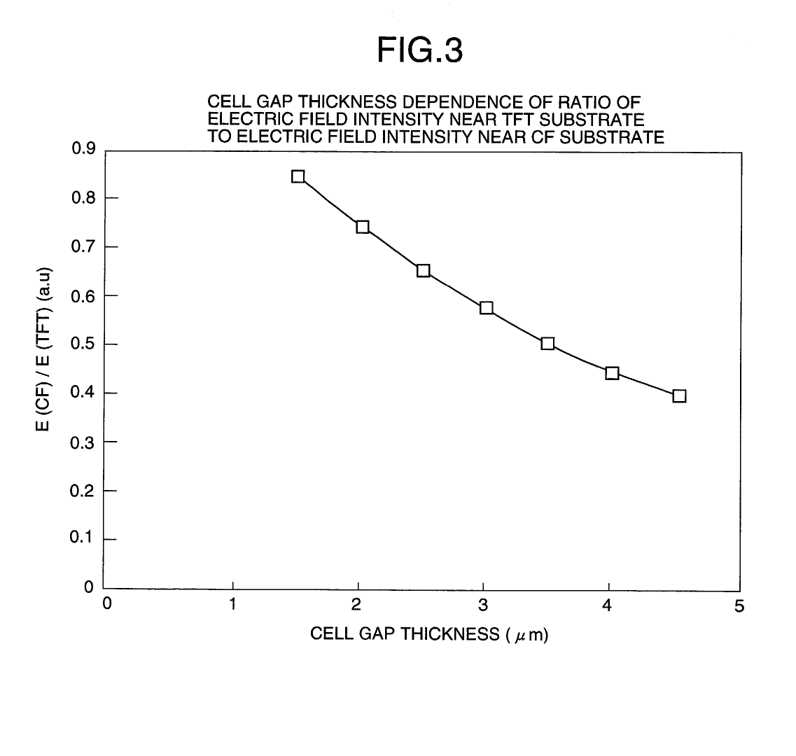

FIG. 4A is a plan view of the TFT substrate of the active matrix type liquid crystal display device for explaining a first and second embodiments of the present invention, and FIG. 4B is a cross sectional view of a liquid crystal panel along a cutting line of FIG. 4A;

FIG. 5 is a cross sectional view of a liquid crystal panel and an enlarged plan view of liquid crystal molecules for explaining the first and second embodiments of the present invention;

FIG. 6 is a graph showing the characteristic of the transmittance to the applied voltage of the liquid crystal panel for showing the effect of the present invention;

FIG. 7 is a graph showing the characteristic of the response time to the applied voltage of the liquid crystal panel for showing the effect of the present invention; and

FIG. 8 is a graph showing the dependence of the transmittance and the contrast to a twist angle in a black display of the liquid crystal panel for showing the effect of the present invention.

### DETAILED DESCRIPTION OF THE PREFERRED EMBODIMENTS

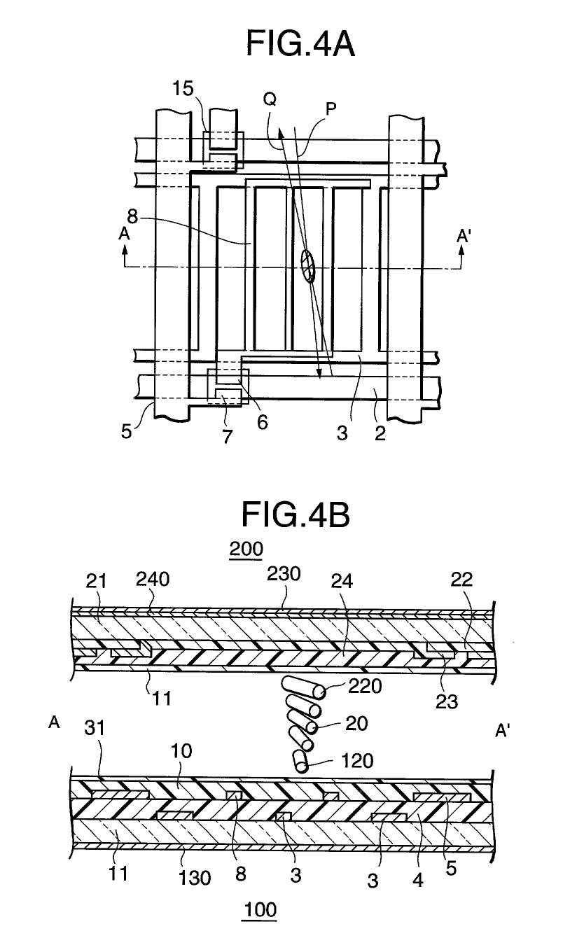

Next, the active matrix type liquid crystal display device of a first embodiment of the present invention will be described by referring to FIG. 4. Here, FIG. 4A is a plan view in which a TFT substrate is seen from a liquid crystal side, and FIG. 4B is across sectional view at the time when the TFT substrate, liquid crystal, and the CF substrate are cut by a plane that passes through a cutting line A-A′ in FIG. 4A and is orthogonal to the TFT substrate. Although the substrate opposing to the TFT substrate is defined as a CF substrate in FIG. 4B, the embodiments of the present invention described hereinafter are not limited to the above-stated configuration that includes the CF substrate with a color filter, but may include a configuration that comprises an opposite substrate without a color filter disposed opposing to the TFT substrate instead of the CF substrate.

Furthermore, although the TFT substrate is described to have no color filter therein and the substrate opposing to the TFT substrate is configured as a CF substrate in FIG. 4B, the embodiments of the present invention described hereinafter are not limited to the configuration that includes the TFT substrate without a color filter and the CF substrate with a color filter, but may include another configuration that comprises a TFT substrate with a color filter therein and instead of the CF substrate, an opposite substrate without a color filter disposed opposing to the TFT substrate.

The display cell shown in the drawing mainly comprises: a TFT substrate 100 including a first glass substrate 1; a CF substrate 200 including a second glass substrate 21, and a liquid crystal 20 held between the TFT substrate 100 and the CF substrate 200.

On one surface of the first glass substrate 1, a gate electrode 2, a common electrode 3, a first insulating film 4, an a-Si film 15, a source electrode 6, a drain electrode 7, a pixel electrode 8, a data line 5, and a protective film 10 are formed. On the other surface of the first glass substrate 1, a polarizer 130 is formed.

On the other hand, on one surface of the second glass substrate 21, a black matrix 22, a color filter 23, and a second insulating film 24 are formed. On the other surface of the second glass substrate 21, a conductive film 240 and a polarizer 230 are formed in order.

Furthermore, on the uppermost surface on the opposing side of each substrate, an alignment layer is formed by a method of offset printing or the like.

The alignment layers of the TFT substrate 100 and the CF substrate 200 obtained by the above-stated method are different from those of the conventional example in that the alignment layers are treated by rubbing so that the alignment layer 11 and the alignment layer 31 have the alignment directions, respectively (the rubbing direction of the alignment layer 11 is P, and the rubbing direction of the alignment layer 31 is Q).

These two substrates are disposed holding a cell gap component (omitted in the drawing) between them to have a specified space, and by enclosing the liquid crystal 20 in that space, a liquid crystal panel is formed as shown in the cross sectional view of FIG. 4B.

That is, the alignment layer 31 of the CF substrate 200 is aligned in the direction Q that is shifted by 19 degrees from the longitudinal direction of the comb tooth shaped common electrode 3 and pixel electrode 8 to the electric field direction to make it easy for the liquid crystal 20 to be rotated by the electric field, and the alignment layer 11 of the TFT substrate 100 is similarly aligned in the direction P that is shifted by 15 degrees to the longitudinal direction of the comb tooth shaped electrodes.

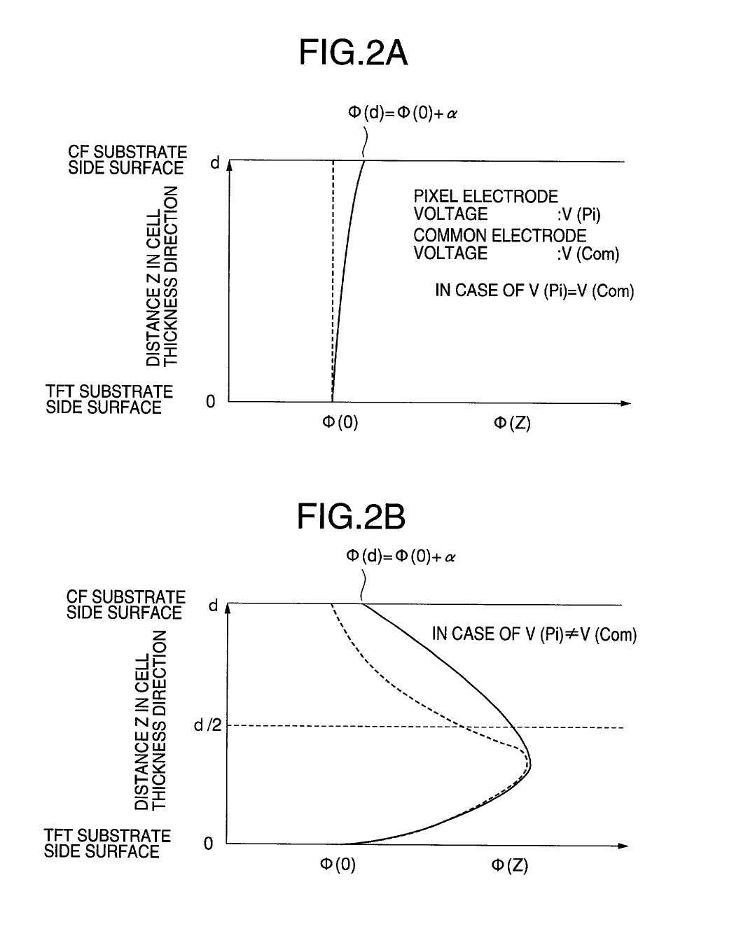

Consequently, in the state of no electric field where no potential difference is generated between the comb tooth shaped common electrode 3 and pixel electrode 8, the initial alignment direction of the liquid crystal 220 near the alignment layer 31 of the CF substrate 200 is subjected to the twist alignment by four degrees (α=4 degrees) to the initial alignment direction (φ(0)=15 degrees) of the liquid crystal 120 near the alignment layer 11 of the TFT substrate 100, as shown by the solid line in FIG. 2A.

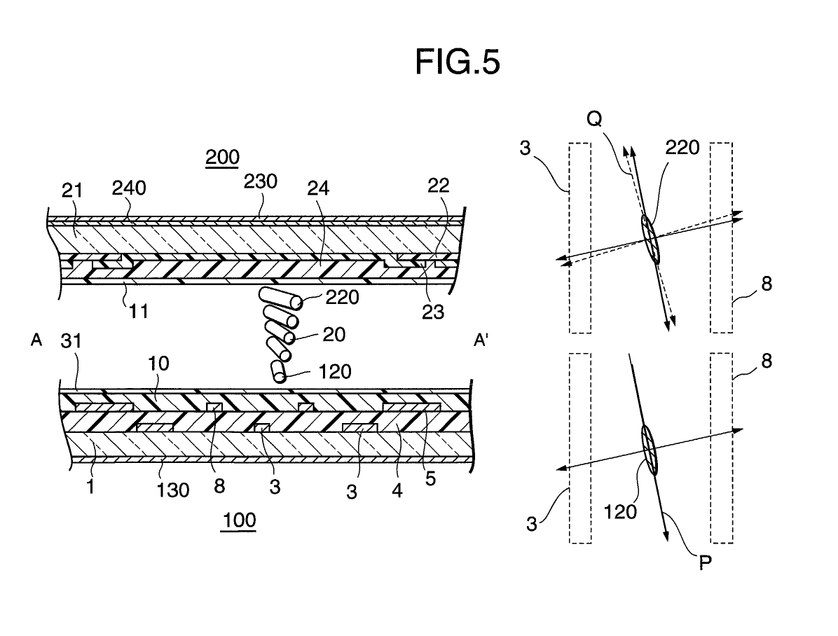

In order to make it easier to understand the above-described relationship between the liquid crystals, 120 and 220, FIG. 5 indicates the state of the initial alignment of the liquid crystal 120 near the alignment layer 11 of the TFT substrate 100 and the liquid crystal 220 near the alignment layer 31 of the CF substrate 200. In FIG. 5, in order that the direction of the initial alignment direction of the liquid crystal becomes clear, an enlarged plan view showing the state in the plane in parallel with the substrate of the liquid crystal is also shown, together with a cross sectional view of the liquid crystal panel. That is, the state of the electrode in the longitudinal direction where the common electrode 3 and pixel electrode 8 of the TFT substrate 100 face to each other is enlarged as a plan view, and as a result, the degree of the liquid crystal rotation positioned in the middle of the electrodes is easily understood.

In the liquid crystal panel formed in the above-described manner, the polarizer 130 on the TFT substrate 100 side coincides its absorption axis with the rubbing direction P of the alignment layer 11 of the TFT substrate 100, and the absorption axis of the polarizer 230 on the CF substrate 200 side is made orthogonal to the absorption axis of the polarizer 130 on the TFT substrate 100 side, which brings about the normally black mode in the panel.

A solid line shown in FIG. 2A schematically shows the liquid crystal alignment state in the cell thickness direction under the condition of no applied voltage in the display cell of the present embodiment. In the case of the IPS-LCD operated in a normally black mode, the pixel electrode potential V(Pi) is equal to the common electrode potential V(Com), and therefore, in the cell thickness direction the liquid crystal is arranged showing the alignment angle ranging from φ(0) to φ(0) +α with respect to the longitudinal direction of the common electrode 3 or the pixel electrode 8 in FIG. 4A.

On the other hand, in the case where a voltage is applied between the common electrode 3 and the pixel electrode 8 of FIG. 4A and an electric field is generated so as to rotate the liquid crystal in the lateral direction, that is, when a potential difference is generated between V(Pi) and V(Com), the liquid crystal 20 rotates in accordance with that electric field intensity, and becomes in a stable alignment state.

A solid line shown in FIG. 2B schematically shows the liquid crystal alignment state in the cell thickness direction under the condition that an electric field is generated in the display cell of the present embodiment. It is understood that the electric field intensity is strong near the TFT substrate 100 side where the comb tooth shaped common electrode 3 and pixel electrode 8 are formed, and therefore, the liquid crystal 120 largely rotates from the initial alignment angle φ(0) . In addition to it, the liquid crystal 220 largely rotates when compared with the broken line showing the state of the liquid crystal rotation of the conventional example, though only a comparatively weak electric field is applied to the liquid crystal 220 near the CF substrate 200 side.

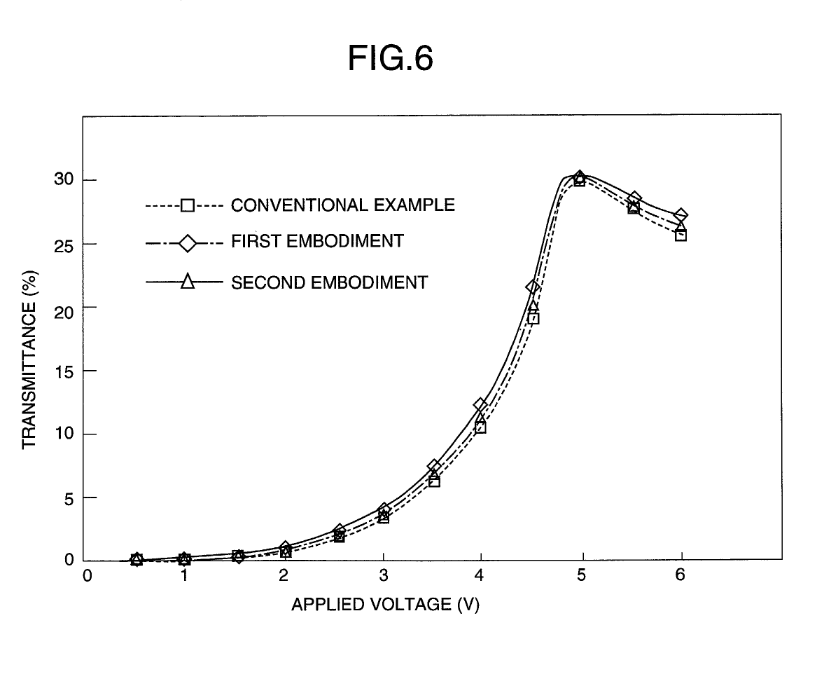

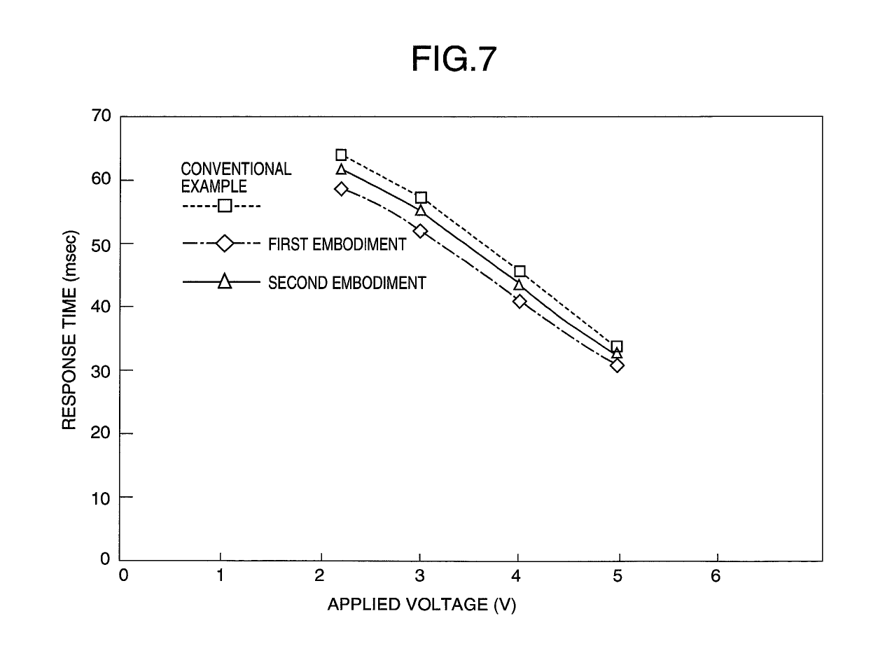

Furthermore, when this liquid crystal panel is assembled in a proper driving device and then the optical characteristics of the panel are measured, the characteristics of the transmittance and the response time to the applied voltage are obtained as shown in FIG. 6 and 7, respectively. It is clear from FIG. 6 that a curve of the transmittance to the applied voltage is shifted to the low voltage side (lowering of the threshold voltage), and besides, a maximum transmittance of the panel increases (increase of the luminance of the display panel). Moreover, as shown in FIG. 7, it is clear that the response time becomes faster under any voltage applied (quickening of the response of the liquid crystal).

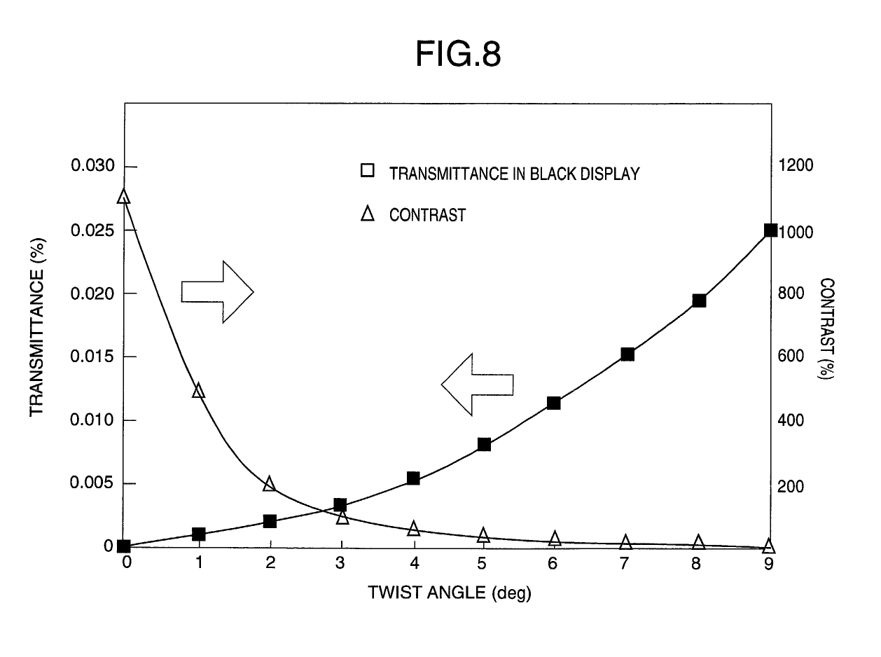

However, there has been such a defect that when a twist angle is set to a larger value of four degrees or more, as shown in FIG. 8, [contrast degradation] is generated, and the contrast is lowered to 100 or less.

Here, the phenomenon called [contrast degradation] will be described.

In the liquid crystal panel of a lateral electric field type, it is supposed that the absorption axes of a polarizer on the TFT substrate side and a polarizer on the opposite substrate (CF substrate in the present invention) side are aligned orthogonal with each other (which is called normally black composition), and the rubbing of the TFT substrate side the opposite substrate side are performed approximately in parallel to each other. In this case, when no electric field is applied to the liquid crystal (that is, the pixel electrode and the common electrode has an equal potential) and the liquid crystals are aligned in the initial alignment direction (rubbing direction), the incident light from the backlight does not penetrate the liquid crystal panel, and therefore, [black display] is made.

In the case of the liquid crystal panel with the above described structure, when an electric field is applied (the pixel electrode and the common electrode have different potentials) to the liquid crystal, the liquid crystal rotates from the initial alignment position, and consequently, the light penetrates the liquid crystal panel because of a birefringence characteristic of the liquid crystal. Particularly, in the case where the liquid crystal rotates by about 45 degrees from an initial alignment angle, [white display] is performed.

However, when the rubbing direction on the TFT substrate side is intentionally shifted from the rubbing direction on the opposite substrate side as described in the present invention, even if no electric field is applied to the liquid crystal to perform black display, since the liquid crystal is subjected to the twist alignment by the degree of intentional shift of the rubbing direction, a little amount of light penetrates the panel in accordance with the birefringence characteristic of the liquid crystal. This state is called [contrast degradation].

Accordingly, in the case of the present embodiment, the twist angle made between the alignment direction of the alignment layer 31 of the CF substrate 200 and the alignment direction of the alignment layer 11 of the TFT substrate 100 is set to four degrees, but by controlling the twist angle from 0.5 to 4.0 degrees, preferable values can be obtained in both the transmittance and the contrast in black display of the liquid crystal panel.

The preferable transmittance and contrast will be described below.

For example, as for the liquid crystal display, the ideal state of the display means a state where light does not penetrate the panel in [black display] at all, and the larger amount of light penetrates in [white display].

Furthermore, the contrast is used as an index given by the value of (transmittance in [white display])/(transmittance in [black display]), and the ideal state of the display is realized at the time of the value indicating infinity.

However, even under the condition of [black display], the transmittance is featured by the state that a little amount of light penetrates the panel because of various causes. Therefore, the liquid crystal panel is designed so that the contrast becomes as high as possible, though not infinite. In the case of the IPS system, the contrast is set to about 200, and this value varies largely depending on the use of the display.

In the present invention, the initial alignment direction of the liquid crystal is intentionally shifted near the upper and lower substrates, and therefore, the transmittance at the time of black display inevitably becomes high, and the contrast is sacrificed to some extent. Accordingly, in the present invention, a manufacturing method of a liquid crystal display device is shown as a second embodiment, wherein the high-speed response can also be attained while keeping the contrast at an ordinary value (about 200).

Furthermore, in the present embodiment, the alignment direction of the alignment layer 11 of the TFT substrate 100 is set to 15 degrees, but it is not limited to this value, and even when the direction is set to the value ranging from 5 to 45 degrees, the similar effect as in the first embodiment is obtained.

Furthermore, in the present embodiment, the above described effect of the present embodiment can be obtained, when the cell gap is set to the value of 1.0 μm to 6.0 μm, and the distance between the comb tooth shaped common electrode and pixel electrode is set to the value of 2 μm to 15 μm.

Next, the active matrix type liquid crystal display device of a second embodiment of the present invention will be described with reference to FIG. 4, also used in the description of the first embodiment.

In the case of the display cell of the present embodiment, the alignment layer 31 of the CF substrate 200 is aligned in the direction that is shifted by 17 degrees from the longitudinal direction of the comb tooth shaped electrodes toward the direction of the electric field so that the liquid crystal 20 can easily be rotated by the electric field. The alignment layer 11 of the TFT substrate 100 is aligned in the direction that is shifted by 15 degrees to the longitudinal direction of the comb tooth shaped electrodes. These two substrates are disposed holding a cell gap component between them so that they have a specified space, and the liquid crystal 20 is enclosed in that space.

The liquid crystal panel obtained by the above-stated method are further formed in the normally black mode as follows: the polarizer 130 of the TFT substrate 100 is formed to coincide its absorption axis with the rubbing direction P of the TFT substrate 100 side; the absorption axis of the polarizer 230 of the CF substrate 200 is formed to be orthogonal to the absorption axis of the polarizer 130 of the TFT substrate 100. Other structures of the second embodiment are the same as the first embodiment.

When this liquid crystal panel is assembled in a proper driving device and then the optical characteristics of the panel are measured, the characteristics of the transmittance and the response time to the applied voltage are obtained as shown in FIG. 6 and 7, respectively. It is clear from FIG. 6 that a curve of the transmittance to the applied voltage is shifted to the lower voltage side, and besides, a maximum transmittance of the panel increases. Moreover, as shown in FIG. 7, it is clear that the response time becomes faster under any voltage applied. In addition, though the characteristics of the transmittance and the response time to the applied voltage are not so improved as seen in the first embodiment, the higher contrast of over than 200 (indicated as the point corresponding to the twist angle of two degrees) than that of the first embodiment is secured. In the case of the present embodiment, the twist angle made between the alignment direction of the alignment layer 31 of the CF substrate 200 and the alignment direction of the alignment layer 11 of the TFT substrate 100 is set to two degrees, but by controlling the twist angle being set to the value of 1.5 to 2.0 degrees, a liquid crystal panel can be obtained, in which both of the transmittance and the contrast in black display show appropriate values.

In the case of the active matrix type liquid crystal display device according to the present invention, the twist alignment is realized so that the initial alignment angle of the liquid crystal on the opposite substrate side is shifted in advance from the initial alignment angle of the liquid crystal on the TFT substrate side. Consequently, at the time of applying the electric field in the lateral direction, it has become possible to easily rotate the liquid crystal near the opposite substrate side. Furthermore, when this twist angle is made two degrees or less, it has become possible to attain the high-speed response, low threshold value, and high luminance at the same time, while restraining the lowering of the contrast less than that of the case where the twist angle is set to two degrees or more.

What is claimed is:

1. An active matrix type liquid crystal display device, comprising:
a TFT substrate having a common wiring and a source/drain wiring formed on a first substrate, said first substrate being provided with
an insulating film covering said common wiring and said source/drain wiring, said insulating film being coated with a first alignment layer;
an opposite substrate opposing to said TFT substrate having a second alignment layer formed on a second substrate;
a liquid crystal held between said first alignment layer and said second alignment layer; and
a common electrode and a pixel electrode wired in parallel with each other being formed as parts of said common wiring and said source/drain wiring, respectively, so that an angle made between a direction in which said first alignment layer is subjected to aligning treatment and a direction in which said second alignment layer is subjected to aligning treatment is set to a value of 0.5 to 4.0 degrees.

2. The active matrix type liquid crystal display device according to claim 1, wherein said angle made between said direction in which said first alignment layer is subjected to aligning treatment and said direction in which said second alignment layer is subjected to aligning treatment is set to a value of 1.5 to 2.0 degrees.

3. The active matrix type liquid crystal display device according to claim 1, wherein said direction in which said first alignment layer is subjected to aligning treatment has an angle of 5 to 45 degrees with respect to a direction in which said common electrode and said pixel electrode are wired in parallel with each other.

4. The active matrix type liquid crystal display device according to claim 1, wherein an angle made between a direction in which said second alignment layer is subjected to aligning treatment and a direction in which said common electrode and said pixel electrode are wired in parallel with each other is larger than an angle made between said direction in which said first alignment layer is subjected to aligning treatment and a direction in which said common electrode and said pixel electrode are wired in parallel with each other.

5. The active matrix type liquid crystal display device according to claim 1, wherein said TFT substrate and said opposite substrate having said liquid crystal therebetween include a first substrate side polarizer and a second substrate side polarizer on opposite sides opposing to inner sides of said TFT substrate and said opposite substrate facing said liquid crystal, respectively, and in said first substrate side polarizer and said second substrate side polarizer, the absorption axis and transmission axis are mutually orthogonal, and any one of the absorption axis and the transmission axis of said first substrate side polarizer agrees with said direction in which said first alignment layer is subjected to aligning treatment.

6. The active matrix type liquid crystal display device according to claim 1, wherein a distance between surfaces of said first alignment layer and said second alignment layer opposing to each other is set to a value of 1.0 μm to 6.0 μm.

7. The active matrix type liquid crystal display device according to claim 1, wherein a distance between said common electrode and said pixel electrode wired in parallel with each other is set to a value of 2 μm to 15 μm.

8. The active matrix type liquid crystal display device according to claim 1, wherein a gate wiring of a thin film transistor is formed on said first substrate simultaneously with said common wiring.

9. The active matrix type liquid crystal display device according to claim 1, wherein an island disposed above said common wiring and made of a semiconductor film is formed in said insulating film, and said island constitutes an active region of a thin film transistor.
